(19) United States
(12) Patent Application Publication
(10) Pub. No.: US 2006/0131393 A1
(43) Pub. Date: Jun. 22, 2006

(54) Multi-role transaction card

(75) Inventors: Ronald S. Cok, Rochester, NY (US); David L. Patton, Webster, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/021,453

(22) Filed: Dec. 22, 2004

(51) Int. Cl. G06K 5/00; G06K 19/06

(52) U.S. Cl. 235/380; 235/492

(57) ABSTRACT

Transaction cards, transaction card systems, and methods for operating the same are provided. A transaction card has a display, a non-volatile memory having a plurality of transaction data sets each set having data for one of a plurality of transaction partners with whom a consumer holding the transaction card can execute a transaction and an input device adapted to determine a transaction partner for a transaction and to generate a transaction partner signal. A controller is adapted to receive the transaction partner signal, to select a transaction data set based upon transaction partner signal and to cause the display to present an image based upon data in the selected transaction data set, so that said image has image content that is at least in part related to a transaction that can be performed with the determined transaction partner.

### FIELD OF THE INVENTION

This invention relates generally to a display device and, more particularly, to transaction cards having pre-defined content.

### BACKGROUND OF THE INVENTION

Increasingly, consumer transactions with businesses, academic institutions, medical providers, non-governmental organizations and governmental agencies, and other organizations (referred to generally herein as transaction partners) requires a consumer to provide information. To facilitate the process of providing information during such transactions, various transaction partners have offered transaction cards to users. Popular examples of such transaction cards include preferred customer cards, credit cards, debit cards, payment tokens such as radio frequency transponders of the type that are used at automotive refueling stations and mass transit stations to facilitate payment, library cards, medical insurance cards and the like. Such transaction cards simplify a user of the transaction card's interaction with such transaction partners in a variety of ways. For example, in many cases, the transaction card is designed as a faster and simpler way of providing transaction relevant information to the transaction partner.

Conventional transaction cards typically take the form of a printed or embossed card having transaction information defined by the transaction partner thereon. This transaction information can include the transaction partner's trade name and/or trademarks and textual information providing transaction information such as an account number, a name of the recipient and occasionally rules for using the transaction card. Transaction cards typically provide transaction data in a machine-readable form such as a printed barcode, magnetically encoded stripe, or a memory chip such as a so-called smart chip that can store transaction information and can provide the stored transaction information to an appropriate reader. Increasingly, transaction cards incorporate radio frequency transponders, such as radio frequency identification (RFID) that store digital data and can provide this digital data to an external device using radio frequency signals. Such transaction cards may also include authentication and security information, for example Personal Identification Numbers (PINs), required for card use.

Transaction cards provide many advantages to a consumer and to the transaction partners and initially such cards were well received in the market place. However, as such cards have proliferated, consumers are finding it less attractive to accept newly issued cards.

What is needed therefore is a common transaction card that a user can use for transactions with multiple transaction partners.

However, such a multi-use transaction card should still be able to provide transaction partners with many of the same advantages that such transaction partners enjoy with contemporary printed or embossed cards. Specifically, retailers, service providers and other commercial enterprises have found that transaction cards that are printed with retailer information provide the advantage of a mobile billboard advertising the retailer, service provider or other commercial enterprise and reminding the user that the user has an incentive to conduct transactions therewith. However, it will be appreciated that it is not frequently useful to provide printed advertising for specific events on transactions cards as such cards are often held by consumers and not used for a substantial period of time—well after such specific events may have been completed.

What is also needed, therefore, is a transaction card that can be used to increase the advertising value of such a card to retailers and to consumers by providing time sensitive transaction information to a retailer and by ensuring that the advantages of the portable advertising and incentives are not lost.

### SUMMARY OF THE INVENTION

In one aspect of the invention, a transaction card is provided. The transaction card has a display, a non-volatile memory having a plurality of transaction data sets each set having data for one of a plurality of transaction partners with whom a consumer holding the transaction card can execute a transaction and an input device adapted to determine a transaction partner for a transaction and to generate a transaction partner signal. A controller is adapted to receive the transaction partner signal, to select a transaction data set based upon transaction partner signal and to cause the display to present an image based upon data in the selected transaction data set, so that said image has image content that is at least in part related to a transaction that can be performed with the determined transaction partner.

In another aspect of the invention, a transaction system for use with a single transaction card is provided. The system comprises at least two different transaction card readers, each transaction card reader having a transaction card input adapted to receive information from a transaction card during transaction in a manner that is different from at least one of the remaining ones of the at least two transaction card readers. Each transaction card reader is further adapted to provide a signal to the transaction card from which the transaction card can determine a transaction partner and, in response thereto the transaction card will provide information that can be received by the transaction card input in the manner in which the transaction card receiver is adapted to receive the information.

In still another aspect of the invention, a method for operating a transaction card having a memory and a display is provided, in accordance with the method, a transaction partner is determined, transaction data is obtained from the memory based upon the determined transaction partner; and an image is presented on the display based upon the obtained transaction data, so that said image has image content that is at least in part related to a transaction that can be performed with the determined transaction partner.

### BRIEF DESCRIPTION OF THE DRAWINGS

FIG. 1 is a schematic diagram of a transaction display according to an embodiment of the present invention;

FIG. 2 is a schematic diagram showing one embodiment of a transaction card having an efficient component arrangement;

FIG. 3 is an exterior view of one embodiment of a transaction card of the invention with a user input set at one position;

FIG. 4 is an exterior view of the embodiment of FIG. 4 with a user input set at a second different position;

FIG. 5 illustrates one embodiment of transaction data stored in a non-volatile memory of a transaction card of FIGS. 4 and 5;

FIG. 6 illustrates one embodiment of a transaction card system of the invention;

FIG. 7 illustrates one embodiment of transaction data stored in a non-volatile memory of a transaction card that can be used in the transaction card system of FIG. 6;

FIG. 8 illustrates a transaction card associated with a reader device of the transaction card system of FIG. 6;

FIG. 9 illustrates a transaction card associated with a different reader device of the transaction card system of FIG. 6; and

FIG. 10 illustrates a flow diagram of a method for operating a transaction card.

### DETAILED DESCRIPTION OF THE INVENTION

In accordance with various aspects of the present invention, a transaction card, transaction card system and method for operating a transaction card system are provided.

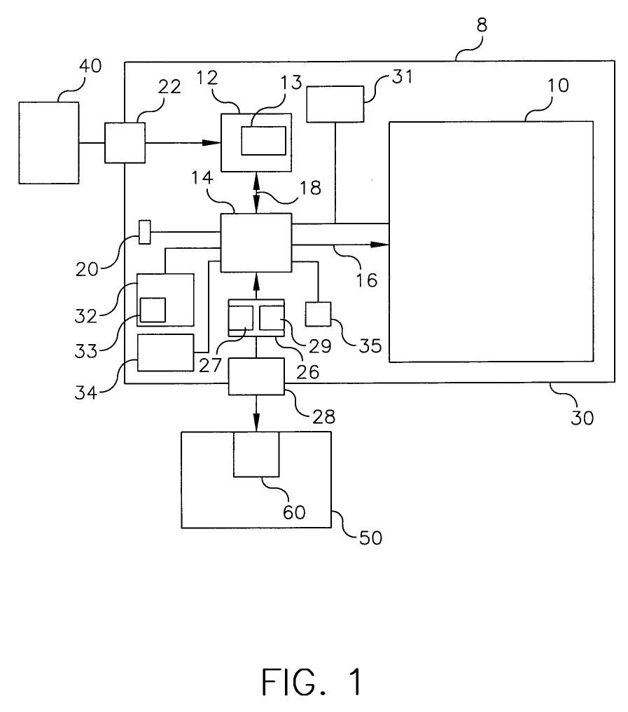

Referring to FIG. 1, one embodiment of a transaction card 8 according to the invention is shown. In this embodiment, transaction card 8 has a display 10, a non-volatile memory 12, a switch 20 for turning the device on or off, and a controller 14 for reading the non-volatile memory 12 and displaying image content on display 10 based upon data obtained from non-volatile memory 12. The embodiment of controller 14 shown in FIG. 1, includes an optional display interface 16 to convert signals from controller 14 into signals that operate display 10 and a memory interface 18 to non-volatile memory 12.

Display 10 can take a variety of forms. For example, display 10 can comprise a convention liquid crystal display, an organic light emitting display (OLED), or a polymer light emitting display (PLED). Examples of such OLEDs and PLEDs are described in the following United States Patents, all of which are incorporated herein by this reference: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

Alternatively, display 10 can comprise a bi-stable cholesteric display device. Such a cholesteric display 10 provides reflective picture elements that have at least two states and that can be transitioned from one state to at least one other state to form images. Once an image is formed, the image will remain on the display for extended periods of time without the application of additional energy to the display. Thus, such cholesteric type displays 10 can provide a non-volatile type of display can be used advantageously to provide images on display 10 without requiring that provide a power constantly for operating controller 14 and for operating display 10 during the presentation of an image on display 10.

Such a cholesteric type display 10 can comprise for example, a reflective passive-matrix display. Such reflective passive matrix displays can be employed advantageously in the present invention because they do not require energy for light emission and are well-suited to low-cost control and manufacturing methods. One such display using bi-stable cholesteric materials is described in U.S. Pat. No. 5,437,811 entitled “Liquid Crystalline Light Modulating Device and Material” issued Aug. 1, 1995. Such displays can be made on flexible substrates and with low-cost roll-to-roll or continuous manufacturing methods thereby reducing cost and providing useful attributes a transaction card 8. In this way, each transaction card 8 can be made inexpensively and in a convenient form factor that is consistent with conventional printed or embossed transaction cards.

Other known displays types can be used for display 10, including but not limited to display types that are formed at least in part using imaging elements that controllably emit light, displays that are formed at least in part using imaging elements that controllably modulate light, and displays that are formed at least in part by imaging elements that controllably reflect light. Examples of such other types of display include but are not limited to displays formed from electrophoretic elements or electro-luminescent display materials.

Non-volatile memory 12 can include multiple components some of which can include volatile read-write memory (e.g. RAM) along with non-volatile memories, such as a read-only memory (e.g. ROM), or a non-volatile read-write memory (e.g. Flash Memory). Such multiple components can comprise separate structures or can be manufactured as an integrated circuit.

At least a portion of non-volatile memory 12 can comprise a locking memory 13. Locking memory 13 can be a memory of a type that will restrict the ability of a user of transaction card 8 to modify the data stored therein. In one embodiment, locking memory 13 comprises a conventional non-volatile programmable read-only memory or a write-once memory. In this embodiment, data can be written to the programmable read-only memory or to the write-once memory but, once written, such data cannot be erased, deleted or modified. In this way, the read-only memory provides a reliable record of data stored therein.

In another embodiment, locking memory 13 comprises a non-volatile read-write memory having a memory interface 18 that permits data to be read or written only where appropriate authorizations or codes are supplied to the write-once memory. In this embodiment, data written to locking memory 13 can be associated with transaction card system 50 in a manner that cannot be modified without appropriate authorizations.

In still another embodiment, locking memory 13 can comprise a conventional non-volatile read-write memory having data stored therein in an encoded or encrypted fashion that is readable by controller 14, but that is difficult for a conventional user of transaction card 8 to understand or reprogram properly. Various well-known encoding or encryption schemes can be used for this purpose.

Controller 14 can be a programmable controller such as a microprocessor, microcontroller, application specific integrated circuit, an arrangement of discrete elements or a programmable analog device. Alternatively, controller 14 can be of a type that is not programmable. Such a non-programmable embodiment of controller 14 can be implemented for example with a state machine or hard-wired logic circuit. In one embodiment, controller 14 can include circuits for performing the functions of a memory interface and display driver. Such an alternative construction provides a low-cost and low-power controller 14 that can perform the functions described herein.

An external interface 22 is optionally provided. In the embodiment shown in FIG. 1, external interface 22 is accessible to external circuitry 40. When external interface 22 is connected to external circuitry 40, for example, by way of a Universal Serial Bus connector, external interface 22 can be used to transmit and receive image content, transaction data or other data from external circuitry 40 and stores this image content in the non-volatile memory 12. Alternative embodiments of the external interface 22 can be provided, for example, by a networked interface to a computer network or the Internet. External interface 22 can be used to set up and program non-volatile memory 12 with image content and transaction data and for programming controller 14.

Communication circuit 26 is provided for enabling communication between transaction card 8 and a card reader 60 of a transaction card system 50. Communication circuit 26 can take a variety of forms, for example it can comprise any other device adapted to encode and decode data for exchange during communication with other devices including but not limited to receiver circuit 27, transmitter circuit 29, transceiver, transcoder or transducer. Where appropriate, a communication access port 28 can be used to provide access to areas outside of a body 30 of transaction card 8 to facilitate communication using communication circuit 26.

Communication circuit 26 can be implemented in a variety of ways, including wirelessly, for example using radio frequency, optical or other known wireless communication circuits such as receiver circuit 27 and optional transmitter circuit 29 to establish a wireless communication path. Examples of such wireless communication systems include but are and not limited to circuits and systems that communicate in ways that that conform to wireless communication standards such as the so-called “Wi-Fi” and so-called “Bluetooth” standards established and described at Institute of Electrical and Electronic Engineers standards 802.11a and 802.11b. Alternatively communication circuit 26 can be adapted to communicate using infrared technology using protocols established by the infrared data association (IrDA). Such protocols include, but are not limited to the serial infrared protocol (SIR) and other protocols developed by the IrDA. In such wireless embodiments, access port 28 provides, for example, an antenna for use in radio frequency communication, or light transmitting and sensing areas adapted to optically exchange data, such as an infrared or other optical interface system known in the art.

In other embodiments, communication circuit 26 having a receiver circuit 27 and an optional transmitter circuit 29 or other such circuits therein that can be adapted for communication with card reader 60 using a direct electrical, magnetic or optical path between access port 28 of the transaction card 8 and card reader 60. In such embodiments access port 28 can comprise, for example, a serial or parallel port, a magnetic strip, or a networked interface to a computer network or the Internet. One example embodiment of a communication circuit of this type is a communication circuit 26 that is adapted to enable communication using hardware and protocols that are consistent with the ELA/TIA-232-E standard entitled “Interface Between Data Terminal Equipment and Data Circuit-Termination Equipment Employing Serial Binary Data Interchange” prepared by the Electronic Industry Association and the Telecommunications Industry Association. Other example embodiments of a communication circuit of this type include circuits and systems that conform with the standards set for the universal serial bus standard, and the IEEE 1394 (so-called “Firewire”) standard. Communication circuit 26 can also comprise circuits and systems that comply with other standards or that comply with proprietary standards. Communication circuit 26 can further be adapted to communicate with magnetic stripe readers and the like using appropriate transducers.

In still another embodiment, communication circuit 26 can have a receiver circuit 27 and an optional transmitter circuit 29 or other such circuits and systems that are adapted to exchange data with a plug-in or other physical connector held by access port 28 of transaction card 8 and moved to an access port 28 of another transaction card so that data can be exchanged using the removable memory card as an intermediary. In an alternative embodiment, a direct link can be established using optional external interface 22 in addition to or in place of access port 28.

In the embodiment shown in FIG. 1, transaction card 8 comprises a power cell 31, for example a battery, that provides power to display 10, non-volatile memory 12, controller 14, display interface 16, memory interface 18, switch 20 and/or external interface 22, and communication circuit 26. In certain embodiments, power can be supplied to these components of transaction card 8 by way of external interface 22 and/or access port 28.

In the embodiment of FIG. 1, transaction card 8 also comprises an optional user input system 32 to enable a user to provide input to controller 14 that controller 14 can use in operating display device 10. For example, controller 14 can determine a transaction type upon the user input as will be described in greater detail below. User input system 32 can comprise a user input device 33 such as for example, a touch screen input, a touch pad input, a two-way switch, a 4-way switch, a 5-way switch, a 6-way switch, an 8-way switch, or any other multi-way switch structure, a stylus system, a trackball system, a joystick system or other such systems.

User input system 32 can also provide an optional audio system 34 incorporated into transaction card 8 to convert audio signals stored in non-volatile memory 12 into an audible form and, optionally, to record audio signals provided by a user. Audio signals can be included as part of transaction data as will be described in greater detail below. Efficient, low cost, audio capture and playback methods are well-known and enabling devices are commercially available. Signals captured by optional audio system 34 can be provided to controller 14 as a transaction type signal or for use in an optional authentication process.

Optional sensors 35 are also shown. Sensors 35 can include light sensors, position sensors, orientation sensors, accelerometers, image capture systems, biometric sensors such as fingerprint scanners or retinal scanners, a gesture recognition system and other sensors known in the art that can be used to detect conditions in the environment surrounding transaction card and/or conditions relevant to a user of transaction card 8 and to convert this information into a sensed condition signal that can be used by controller 14 in governing operation of transaction card 8 and further can be used as an input signal from which controller 14 can determine which transaction partner transaction card 8 is being used. An image sensor may be incorporated into the display 10 itself, for example to provide near-field image sensing without use of lenses. This is particularly useful, for example, in acquiring fingerprint images by placing a finger directly on the display. Such combination sensors and displays are known and described in the art, for example in U.S. Pat. No. 6,717,560 entitled “A Self-Illuminating Imaging Device”, issued Apr. 6, 2004 to Cok et al. Fingerprints may usefully serve as both identification and authentication for transactions according to an embodiment of the present invention.

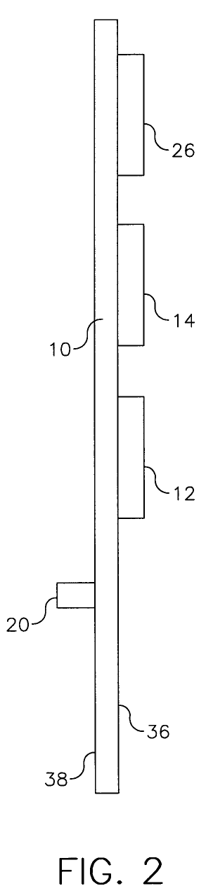

It is useful to minimize the thickness of transaction card 8 to mimic, as closely as possible, conventional printed communications for example, cards, photographic prints, paper media and the like. To this end, the components such as non-volatile memory 12, controller 14, and switch 20 that are used in various embodiments of transaction card system 50 can be assembled on a back 38 or front 36 of display 10 as shown in the embodiment shown in FIG. 2. In particular, it may be useful to have a non-volatile memory 12, controller 14 and communication circuit 26 affixed to the back side 38 of display 10 and switch 20 to be affixed to a front side 36 of display 10 or otherwise positioned so that it can be conveniently actuated by a user of transaction card 8. In this way, transaction card 8 can take a form that is consistent with the form of a conventional transaction card such as a credit card, debit card, insurance identification card, driver's license, voter registration card, shopper club card, preferred customer card and the like. Transaction card 8 and display 10 can also be incorporated onto rigid or flexible and/or foldable substrates to provide a wide variety of useful shapes.

Controller 14 and non-volatile memory 12 can be combined into a single integrated circuit and/or potted together, for example, using a protective resin to provide a small, low-cost circuit. Any protective material applied to the circuitry can be applied after the image content and transaction data is written to the non-volatile memory 12.

In operation, transaction data is written into non-volatile memory 12. This can be done before assembly of transaction card 8 by preprogramming such information into non-volatile memory 12. This can also be done after assembly using external circuitry 40 to program such information into non-volatile memory 12 by way of external interface 22. In still another embodiment wired or wireless signals can be provided to communication circuit 26 to program transaction data and any other data into non-volatile memory 12 and/or non-locking memory 13.

The transaction data stored in non-volatile memory 12 is generally organized into a plurality of transaction data sets each having data for one of a plurality of transaction partners with whom a consumer can use the transaction card during a transaction. Each set of transaction data includes information that can be used by controller 14 to cause display 10 to present an image for a particular transaction partner having image content that is relevant to the transaction partner in connection with the transaction. Typically, each set will incorporate data from which controller 14 can cause display 10 to present at least in part one of graphic information, icons, logos, trademarks, promotional information, direction information, contact information, sale information, discount information, directional information, images, text, identification characteristics, images, image sequences, video authentication imagery, steganographic information, encoded information, and/or authentication information related to one or more types of transactions with a single transaction partner or group of transaction partners who have agreed to operate in a consistent fashion.

The transaction data can also include other information such as a user identification, for example fingerprints or images of the user or other biometric identification, a display card identification, a retailer identification, insurance identification, next of kin contact identification, transaction identification, and payment information, delivery information, credit information, debit information.

In one embodiment, a purchaser of transaction card 8 can add personalization data to the transaction card. For example personalization data can be provided example by transmitting the personalization data through the external interface 22, or communication circuit 26. Such personalization data can include, for example, names, addresses, images, graphic representations, text, audio, and video signals, user preferences for the way in which transaction card 8 is to operate. Personalization data can also be entered using of user input system 32 of transaction card 8. For example, during an initial set-up phase of operation of transaction card 8, controller 14 can require an operator to provide personalization data through user-input system 32. The external circuitry 40 can also provide additional power to transaction card 8 during writing and may also charge power cell 31.

In certain embodiments, where transaction card 8 has confidential information stored therein such as information that identifies a user by name, account number, social security number, or other sensitive personal, financial or medical information. Such confidential information can be stored as transaction data where it is relevant to such transactions. Such confidential information can also be stored in other fashions.

In any embodiment, transaction card 8 can use a locking memory 13, to store at least some of the transaction data in a protected fashion. For example, locking memory 13 can be used to store sets of transaction data or portions of the same in a protected fashion. Locking memory 13 can also be used to store personalization data or other confidential or private data. By storing such information in the locking memory 13, such information is protected from change or modification. This can be used, for example, to ensure that selected data sets or selected user information is protected from unintended editing or review.

Some or all of the data stored in non-volatile memory 12 can also be stored in non-volatile memory 12 in a manner that allows for selected portions of selected transaction data sets to be edited, deleted or revised.

Each transaction card 8 has at least two sets of transaction data stored therein relevant to transactions with at least two different transaction partners. Transaction cards 8 can be provided that are capable of supporting a wide range of transaction types with each transaction partner. For example, where transaction card 8 has transaction data sets associated with two different retailers, transaction card 8 can have transaction data that is useful in performing purchase and return transactions with each of the two different retailers.

Different transaction cards can be selected by a user, each adapted for use with different combinations of transaction partners. Such transaction cards can be sold at different prices to reflect market conditions. Alternatively, a group of transaction partners may agree to cooperatively provide a transaction card having transaction data for each of the members of the group.

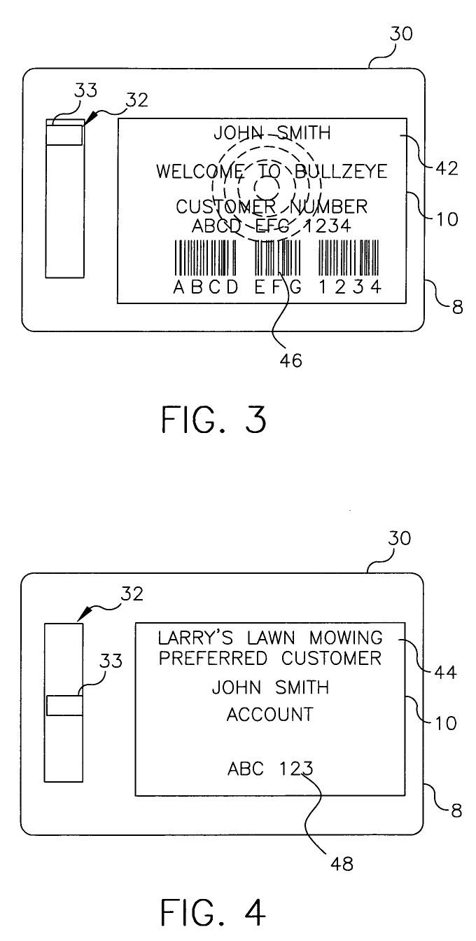

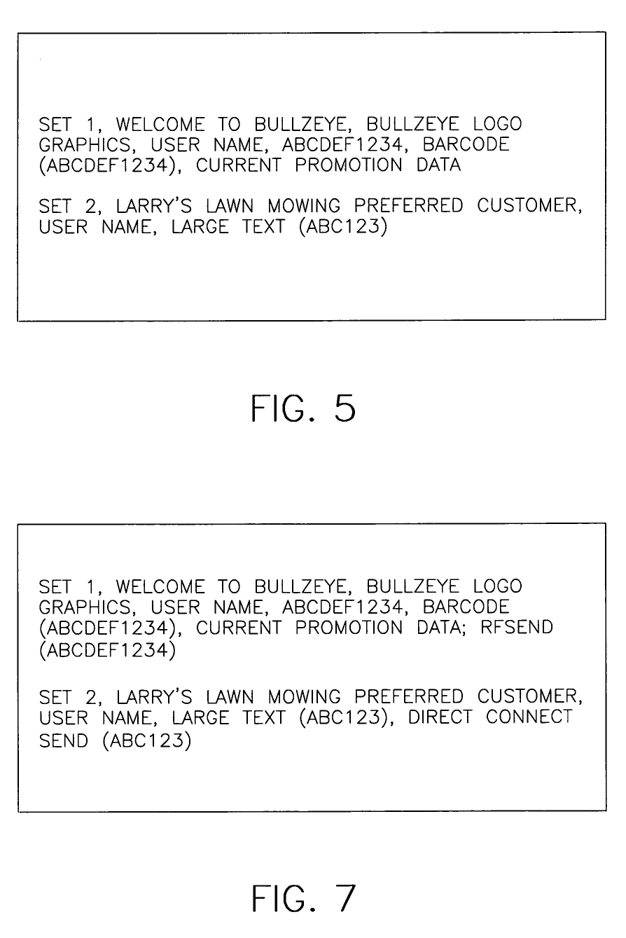

In an example shown in FIGS. 3-5, a user input system 32 comprising a user input device 33 provides a transaction partner signal to the controller 14 in a transaction card 8 of the embodiment shown in FIG. 1, having transaction data of the type illustrated in FIG. 5 stored therein. Controller 14 is adapted to receive the transaction partner signal and to select from between transaction data sets 1 and 2 based upon the transaction partner signal. Where user input device 33 is in the position shown in FIG. 3, controller 14 causes display 10 to present an image 42 based upon the data stored in the selected transaction data set 1 and having image content therein that is relevant to the Bullzeye transaction partner. Similarly, as shown in FIG. 4, when controller 14 receives a transaction partner signal that causes controller 14 to use data stored in transaction data set 2 controller 14 causes an image 44 to be presented on display 10 that is based upon information in data set 2 and that causes an image to be presented on display 10 having image content therein that is relevant to the Larry's Lawn Service transaction partner. The presented image can incorporate some type of information such as a bar code 46 shown in FIG. 3, text 48 shown in FIG. 4 or other information that can be read and used in the transaction such as graphics, text or machine readable information.

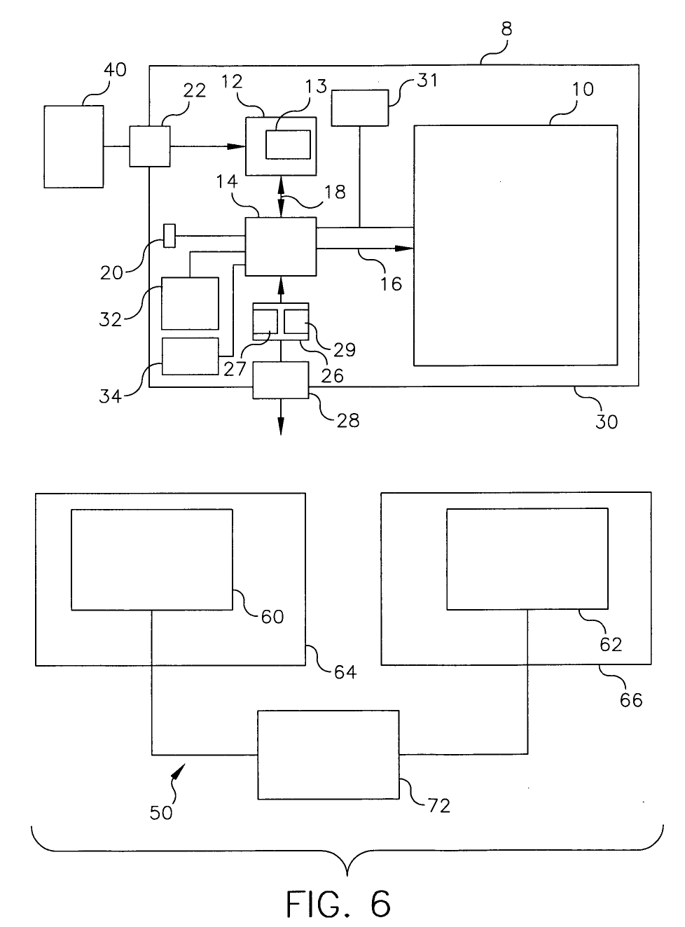

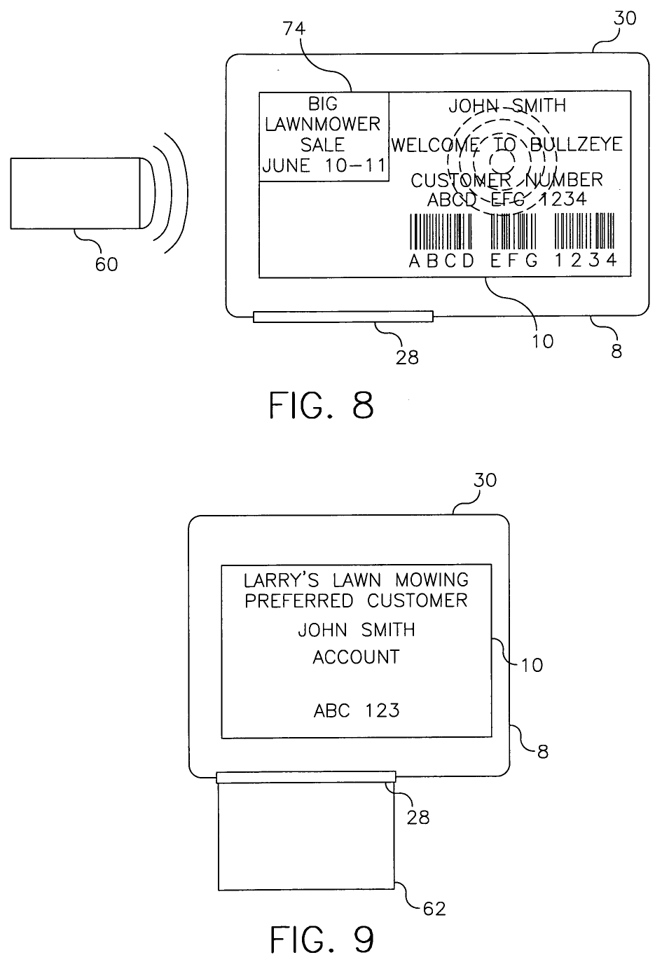

FIGS. 6-8 show yet another embodiment of the present invention. As is shown in FIG. 6, a transaction card system 50 is provided having a plurality of transaction card readers shown for simplicity in FIG. 6 as comprising readers 60 and 62. A first transaction partner 64 provides card reader 60 while a second transaction partner 66 provides card reader 62. Transaction card reader 60 is adapted to communicate with transaction card 8 in one manner while card reader 62 is adapted to communicate with a transaction card 8 using a different manner of communication. For example, as shown in FIG. 6, card reader 60 can be adapted to communicate with a transaction card using radio frequency signals, while reader 62 can be adapted to communicate with a transaction card 8 using a direct contact electrical connection between reader 62 and transaction card 8 that is so adapted. As is also shown in FIG. 6, different types of data are provided to card reader 60 and to card reader 62. As is shown in FIG. 7, each transaction card 8 has a transaction data set each associated with one of the first transaction partner 64 and second transaction partner 66. FIG. 8 illustrates the appearance of one embodiment of a transaction card 8 while in communication with card reader 60 while FIG. 9 illustrates the appearance of the embodiment of transaction card 8 while in communication with reader 62.

In the embodiment illustrated in FIGS. 6-10, transaction card 8 is adapted for use with both card reader 60 and with reader 62. In this regard, transaction card 8 has two sets of transaction data stored in non-volatile memory 12, shown in FIG. 7 as a first set 68 associated with transaction partner 64 and a second set 70 associated with transaction partner 66. A communication circuit 26 is adapted for communication with both of card readers 60 and 62.

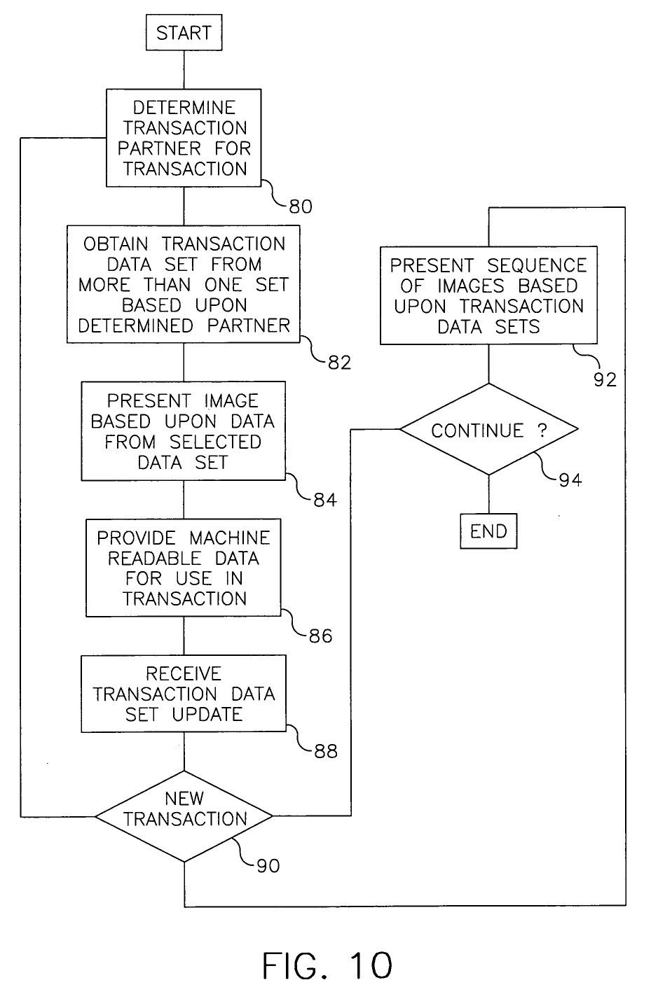

Controller 14 is operated, in this embodiment the manner illustrated in FIG. 10, which shows a flow diagram of a method for operating transaction card 8. In a first step of the method, a determination is made as to which transaction data set to be used and which type of communication to use based upon a transaction partner signal (step 80). In this embodiment, a receiver circuit 27 of communication circuit 26 is adapted to receive optical, electrical, magnetic or other signals from one of reader devices, for example card reader 60 using a wireless communication link such as radio frequency signals and to receive signals from reader 62 by way of a wired communication link through port 28. Receiver circuit 27 determines a transaction partner signal based upon whether signals are received in a wired or wireless form. It will be appreciated that such discrimination can be made by receiver circuit 27 in other ways, including but not limited to sensing the form, type or content of communication from a reader device at receiver circuit 27. Alternatively, an input system 32 can generate a transaction partner signal based upon an input at a user input device 33, audio system 34, or sensor system 35.

Once that controller 14 receives the transaction partner signal controller 14 can select a transaction data set based upon transaction partner signal and can cause an image to be presented on display 10 (step 82). Controller 14 then causes display 10 to present an image based upon the data stored in the selected transaction data set so with the image being based upon data from the selected data set, and having image content that is at least in part related to a transaction that can be performed with the determined transaction partner (step 84). In one embodiment of this type, controller 14 causes some form or output signal to be provided in a machine-readable form (step 86). For example, controller 14 can cause a transmitter circuit 29 in the communication circuit to generate signals based upon transaction data, said signals being generated in a form that is readable by card reader 60. For example, communication circuit 26 can have a transmitter circuit 29 that is adapted to generate radio frequency signals, the frequency, content, and pattern of which are adapted to be read by card reader 60.

In the embodiment illustrated in FIGS. 6-10, when a transaction partner signal is provided to controller 14 indicating that transaction card 8 is to be used in a transaction with transaction partner 64, such as when a wireless communication link is established between transmitter circuit 29 and reader 62, controller 14 is further adapted to obtain data from the transaction data set associated with transaction partner 64 and to cause display 10 to present an image 70 based upon the data stored in the selected transaction data set so that display 10 presents transaction specific information that is relevant to transactions with transaction partner 64. In the embodiment shown, transmitter circuit 29 is further operable to generate electronic signals that are detectable by reader 62 when contacts (not shown) of reader 62 and that provide information that can be usefully applied to facilitate the transaction. In like fashion a transaction card 8 can be adapted for use with more than two transaction partners.

Similarly, in the embodiment illustrated in FIGS. 6-10 when a transaction partner signal is provided to controller 14 indicating that transaction card 8 is to be used in a transaction with transaction partner 66, such as when a direct communication link is established between receiver circuit 27 and reader 62 of transaction partner 66, controller 14 is further adapted to obtain data from the transaction data set associated with transaction partner 66 and to cause display 10 to present an image 72 based upon the data stored in the selected transaction data set so that the presented image has image content that is at least in part related to a transaction that can be executed with transaction partner 66. In the embodiment shown, transmitter circuit 29 is further operable to generate electronic signals that are detectable by reader 62 when contacts (not shown) of reader 62 and that provide information that can be usefully applied to facilitate the transaction. In like fashion a transaction card 8 can be adapted for use with more than two transaction partners.

A valuable aspect of a transaction card 8 of certain embodiments of the invention is the ability of such a transaction card 8 to provide a form of advertising that travels with the card. In the embodiment of FIGS. 6-8, such advertising is provided by specially adapting controller 14 to be operable in at least when not used during a transaction (step 90) to present a cycle of images on display 10 so that a consumer can observe all of the images associated with transaction card 8 in such a repeating cycle (step 92). Typically such images will comprise the same images that are presented when a transaction is initiated with a particular transaction partner. In an alternate embodiment, each transaction partner can also arrange to have specialized images presented when operated in this mode. In this way, the transaction partners who have contributed to providing a transaction card 8 can be assured that each will have an adequate opportunity to use display 10 to present the images provide as mobile advertising and incentives. Such a cycle can continue indefinitely, or for a period of time determined by the controller 14. Alternatively a user can disable such a cycle by making an appropriate input into user input system (step 94).

Further, as is shown in FIGS. 6-10, in certain embodiments, a transaction card 8 can be used in a manner that permits time sensitive advertisements or other promotional information 74 to be recorded in non-volatile memory 12 by any reader in transaction card system 50, including card readers such as reader 60 or reader 62. In this regard it will be appreciated that each time that a user provides a transaction card 8 to a properly equipped reader such as reader 60, a writing portion 63 of reader 60 such as a wireless transmitter can be incorporated therein that is adapted to encode time-sensitive promotional material in a data set for a particular transaction partner so that the time sensitive promotional material 74 can be presented as a part of an image presented for particular transaction (step 88).

In particular, reader 60 and reader 62 can be associated with a communication system 76 that provides promotional material for all or more than one of the transaction partners 64 and 66 associated with the transaction card 8 so that any time that a transaction card 8 is presented to a reader such as reader 62, promotional material for all of the transaction partners can be recorded by a writing portion 63 of reader 60 or a writing portion 65 of reader 62. This increases the frequency with which updates of the promotional material or other transaction data can be stored in transaction card 8. Further, such promotional material 74 can be provided with an expiration data associated therewith so that controller 14 can suspend presentation of the promotional material after the end of the promotion.

In one embodiment of the invention, communication circuit 26 can be adapted to sense wireless signals having updated promotional or updated information relevant to a data set even in situations wherein the transaction card 8 is not being used. Where communication circuit 26 detects such signals, communication circuit 26 can extract any relevant updates from such wireless signals and to adjust the data in the relevant transaction data sets to reflect such updates.

The invention has been described in detail with particular reference to certain preferred embodiments thereof, but it will be understood that variations and modifications can be effected within the spirit and scope of the invention.

### Parts List

8 transaction card
10 display
12 non-volatile memory
13 locking memory
14 display controller
16 display interface
18 memory interface
20 switch
22 external interface
26 communication circuit
27 receiver circuit
28 access port
29 transmitter circuit
30 body
31 power cell
32 user input system
33 user input device
34 audio system
35 sensors
36 front of display
38 back of display
40 external circuitry
42 image
44 image
46 barcode
48 text
50 transaction card system
60 transaction card reader
62 transaction card reader
63 writing portion
64 transaction partner
65 writing portion
66 transaction partner
74 promotional material
76 communication system
80 step
82 step
84 step
86 step
88 step
90 step
92 step
94 step

1. A transaction card comprising:
a) a display;
b) a non-volatile memory having a plurality of transaction data sets each set having data that is indicative of one of a plurality of transaction partners with whom a bearer of the transaction card can execute a transaction;
c) an input device adapted to determine a transaction partner for a transaction and to generate a transaction partner signal; and
d) a controller adapted to receive the transaction partner signal, to select a transaction data set based upon transaction partner signal and to cause the display to present a transaction-specific image based upon the data stored in the selected transaction set so that the display presents transaction specific information that is relevant to transactions with the determined transaction partner.

2. The transaction card of claim 1, wherein the transaction data provides data that can be used by controller to generate an image on display that can be used during the transaction.

3. The transaction card of claim 1, wherein the transaction data includes data from which controller can cause the display to present at least in part one of graphic information, icons, logos, trademarks, promotional information, direction information, contact information, sale information, discount information, directional information, images, text, identification characteristics, images, image sequences, video and audio authentication imagery, steganographic information, encoded information, and authentication information.

4. The transaction card of claim 1, wherein the transaction data includes at least one of a user identification, a retailer identification, insurance identification, next of kin identification, transaction identification, and payment information, delivery information, credit information, debit information.

5. The transaction card of claim 1, wherein said input comprises a receiver circuit adapted to receive signals from a reader device of a transaction system wherein the communication circuit is adapted to determine a transaction partner based upon the received signals from the reader device.

6. The transaction card of claim 1, further comprising transmitter circuit adapted to generate signals based upon transaction data, said signals being generated in a form that is readable by at least one of an optical, electrical, and magnetic reader device of a transaction system.

7. The transaction card of claim 6, wherein said transmitter is operable to generate signals in more than one form and wherein the form is selected based upon the determined transaction partner.

8. The transaction card of claim 1, wherein said display comprises at least one of a display formed at least in part by imaging elements that controllably emit light, a display formed at least in part by imaging elements that controllably modulate light, and imaging elements that controllably reflect light.

9. The transaction card of claim 1, wherein the display comprises an organic light emitting display, polymer light emitting display, a cholesteric display, a display formed from bi-stable materials, a display formed from electrophoretic elements or an electro-luminescent display.

10. The transaction card of claim 1, wherein the input circuit comprises a user input device adapted to convert a user input action into a transaction partner signal.

11. The transaction card of claim 1, wherein the input circuit comprises an audio capture system or other sensor adapted to sense conditions form which the controller can determine a transaction partner.

12. The transaction card of claim 1, wherein the display is operable in at least one mode to present transaction specific data for different transaction types in a cycle so that an observer can observe all of the transaction specific images associated with the transaction card within a period of time.

13. The transaction card of claim 1, wherein at least one of the transaction data sets includes promotional data for presentation on display when a transaction specific image is presented on the display.

14. The transaction card of claim 1, wherein the display further includes means to acquire an image.

15. The transaction card of claim 1, wherein the image acquired is a fingerprint.

16. A transaction system for use by a plurality of transaction partners, the system comprising
at least two different transaction card readers, each transaction card reader having a transaction card input adapted to receive information from a transaction card during transaction in a manner that is different from the remaining ones of the at least two transactions;
said transaction card reader being adapted to provide a signal to the transaction card from which the transaction card can determine a transaction partner and, in response thereto the transaction card will provide information that can be received by the transaction card input in the manner in which the transaction card receiver is adapted to receive the information.

17. The transaction system of claim 16, wherein each transaction card reader further comprises a transaction card transmitter circuit adapted to store transaction data in a memory in the transaction card.

18. The transaction system of claim 16, wherein each transaction card reader is operable to store promotional information for more than one of the transaction partners in a memory in the transaction card.

19. A method for operating a transaction card having a memory and a display, the method comprising the steps of:
providing a transaction card having a non-volatile memory with stored transaction data;
determining a transaction partner;
obtaining transaction data from the memory based upon the determined transaction partner; and
presenting an image on the display based upon the obtained transaction data, so that said image has image content that is at least in part related to a transaction that can be performed with the determined transaction partner.

20. The method of claim 19, further comprising the steps of receiving data representing promotional material relevant to a transaction partner and presenting the promotional material on the display.

21. The method of claim 19, further comprising the steps of determining when a transaction is not occurring and presenting a cycle of images on the display based upon the obtained transaction data.

22. The method of claim 19, further comprising the step of providing an output signal in a form that is readable by a reader of the selected transaction partner.

23. The method of claim 19, further comprising the step of sensing for signals containing updated transaction data, downloading the updated transaction data and storing the updated transaction data in a memory.

24. A method for operating a transaction card having a memory and a display, the method comprising the steps of:
providing a transaction card having a non-volatile memory;
determining a transaction partner;
obtaining transaction data from the transaction partner, wherein the transaction data includes at least one image or graphical element; and
storing the transaction data, so that said image or graphical element has content that is at least in part related to a transaction that can be performed with the determined transaction partner using the transaction data.
